(19) United States
(12) Patent Application Publication
(10) Pub. No.: US 2005/0257002 A1
(43) Pub. Date: Nov. 17, 2005

(54) Apparatus and method for neighbor cache table synchronization

(75) Inventor: Tuyen Nguyen, San Ramon, CA (US)

Correspondence Address: DARBY & DARBY P.C., P.O. BOX 5257, NEW YORK, NY, 10150-6257, US

(73) Assignee: Nokia, Inc., Irving, TX (US)

(21) Appl. No.: 10/837,559

(22) Filed: Apr. 30, 2004

(51) Int. Cl. G06F 12/16

(52) U.S. Cl. 711/114

(57) ABSTRACT

A method and apparatus for synchronizing a neighbor cache table of a backup network device and with a neighbor cache table of a master network device is provided. The master network device may send an Add command or a Delete command to the backup network device whenever entry is added or deleted from the neighbor cache table of the master network device. Further, when a new network device joins the link to become master or backup, synchronize request and synchronize acknowledge commands may be employed to synchronize the new network device with the master network device. Additionally, when a network device becomes the master, it may send an update command to enable the neighbor switch devices to update their neighbor cache table, if any, to redirect traffic to the network device.

### FIELD OF THE INVENTION

The invention is related to computer networks, and in particular, to an apparatus and method for synchronizing a neighbor cache table in a backup device with a neighbor cache table in a master device.

### BACKGROUND OF THE INVENTION

Packet forwarding works by forwarding remotely-destined packets to a forwarding node that has a path to the destination. In some cases, the traffic may be sent to a forwarding node. For example, the forwarding node may include a firewall. However, unavailability of the forwarding node may cause the destination to become unreachable.

To alleviate this problem, multiple independent devices can be used that can redundantly serve as forwarding nodes. So, if a redundant device is unavailable, then another redundant device may take its place. The fail-over of one redundant device to another may be achieved by running a high-availability (HA) protocol.

### BRIEF DESCRIPTION OF THE DRAWINGS

Non-limiting and non-exhaustive embodiments of the present invention are described with reference to the following drawings, in which:

FIG. 1 illustrates a block diagram of an embodiment of a system;

FIG. 2 shows a flow chart of an embodiment of a process for the system of FIG. 1;

FIG. 3 illustrates an embodiment of system that is arranged for neighbor cache table synchronization for a high-availability system; and

FIGS. 4-5 show a flow chart of an embodiment of a process for neighbor cache table synchronization in a high-availability system, in accordance with aspects of the invention.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context clearly dictates otherwise. The meanings identified below are not intended to limit the terms, but merely provide illustrative examples for the terms. The meaning of “a,” “an,” and “the” includes plural reference, and the meaning of “in” includes “in” and “on.” The phrase “in one embodiment,” as used herein does not necessarily refer to the same embodiment, although it may. The term “signal” means at least one current, voltage, charge, temperature, data, or other signal.

Briefly stated, the invention is related to a method and apparatus for synchronizing a neighbor cache table of a backup network device and with a neighbor cache table of a master network device. The master network device may send an Add command or a Delete command to the backup network device whenever entry is added or deleted from the neighbor cache table of the master network device. Further, when a new network device joins the link to become master or backup, synchronize request and synchronize acknowledge commands may be employed to synchronize the new network device with the master network device. Additionally, when a network device becomes the master, it may send an update command to enable the neighbor switch devices to update their neighbor cache table, if any, to redirect traffic to the network device.

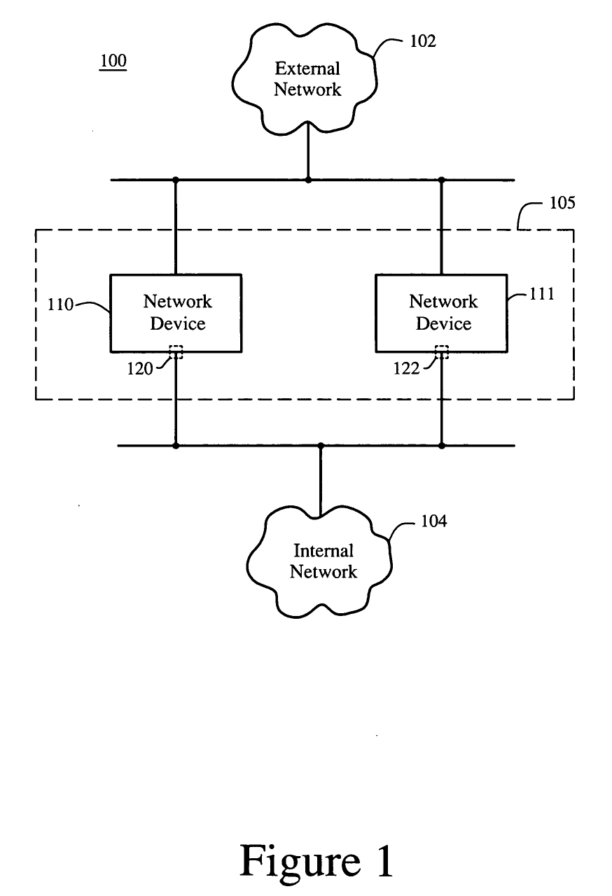

FIG. 1 illustrates a block diagram of an embodiment of system 100. System 100 includes external network 104, which can include a local area network, the Internet, and the like. System 100 also includes internal network 104, which may include local area networks, and the like. System 100 also includes high-availability (HA) system 105, which includes network devices 110 and 111. Network device 110 includes transceiver 120. Network device 111 includes transceiver 122. Further, network devices 110 and 111 may be any one of a router, bridge, firewall, proxy server, switch, a layer-2 forwarding node, and the like. Network devices 110 and 111 are each arranged to transmit and receive packets by employing transceivers 120 and 122, respectively. Also, although not shown, network devices 110 and 111 each include a processor that is configured to perform actions.

Additionally, HA system 105 may be arranged such that, at any time, one of the network devices in HA system 105 assume the role of master, and one or more of the other network devices in HA system 105 may be arranged to assume the role of backup. In one embodiment, network device 110 is configured as a default master, and network device 111 is configured as a backup network device for the default master. In this embodiment, network device 110 assumes the master role initially. However, if a failure condition occurs in network device network 110, network device 111 may assume the role of master.

The high-availability arrangement may be achieved by employing a high-availability protocol. Examples of high-availability protocols include but are not limited to “Virtual Router Redundancy Protocol” (VRRP), “Hot Standby Router Protocol” (HSRP), “IP Standby Protocol” (IPSTB), and the like.

Also, network device 110 and 111 may each store a neighbor cache table. A neighbor cache table may also be referred to as an “address table”, a “bridge table”, and the like. The master (i.e. the device that is assuming the master role) is arranged to forward packets based, in part, on its neighbor cache table. In addition to employing an HA protocol, network devices 110 and 111 also employ a protocol for neighbor cache table synchronization.

In one embodiment, an existing protocol, unrelated to neighbor cache table synchronization, is employed to perform neighbor cache table synchronization by adding new commands to the existing protocol. In other embodiments, a separate protocol for neighbor cache table synchronization may be employed.

If the network device (110 or 111) that is assuming the master role receives a packet (that is not associated with the HA protocol, the neighbor cache table synchronization protocol, or the like), it forwards the packet, based, in part, on the neighbor cache table. If the network device (110 or 111) that is assuming the backup role receives a packet (that is not associated with the HA protocol, the neighbor cache table synchronization protocol, or the like), it may drop the packet. Accordingly, the master controls the forwarding of the packets. If a fail-over occurs, control of the forwarding is failed-over to the new master.

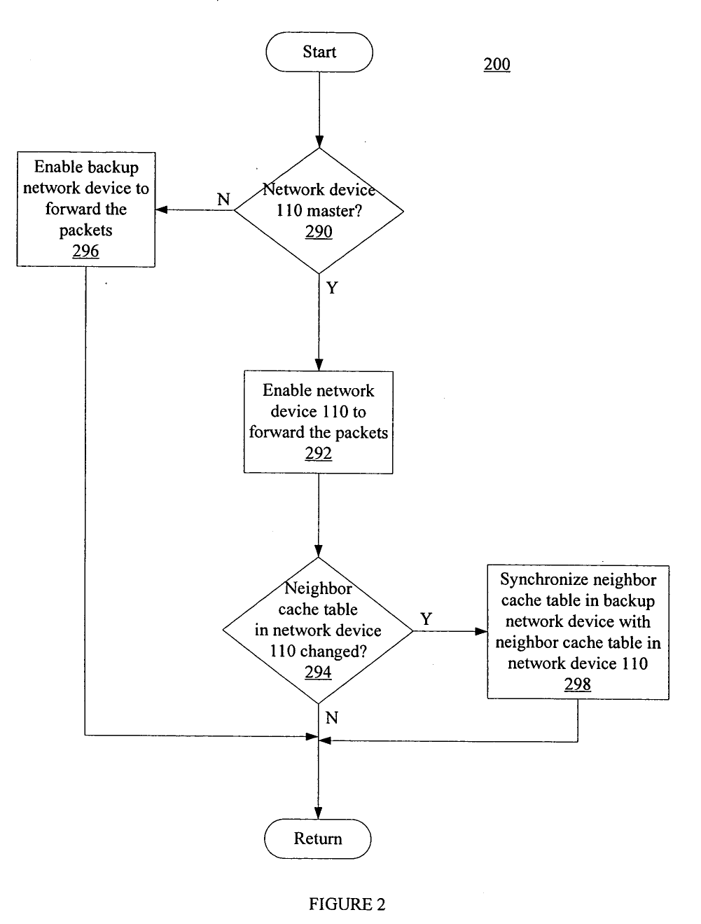

FIG. 2 shows a flow chart of an embodiment of process 200. In one embodiment, process 200 is employed by system 100. Process 200 is a process for forwarding packets that are sent to an HA system, such as HA system 105.

After a start block, the process proceeds to decision block 290, where a determination is made as to whether network device 110 is assuming the master role. If so, the process advances to block 292, where network device 110 is enabled to forward packets sent to the HA system for forwarding.

The process then moves from block 292 to decision block 294, where a determination is made as to whether the neighbor cache table in network device 110 has changed. If the neighbor cache table in network device 110 has not changed, the process advances to a return block, where other processing is performed. However, if the neighbor cache table in network device 294 has changed, the process proceeds to block 298, where the neighbor cache table in at least one backup network device (e.g. network device 111) is synchronized with the neighbor cache table in network device 110. The process then moves from block 298 to the return block, where other processing is performed.

At decision block 290, if network device 110 is not assuming the master role, the process proceeds to block 296, wherein a backup network device (e.g. network device 111) is enabled to forward the packets sent to the HA system for forwarding. The process then advances from block 296 to the return block, where other processing is performed.

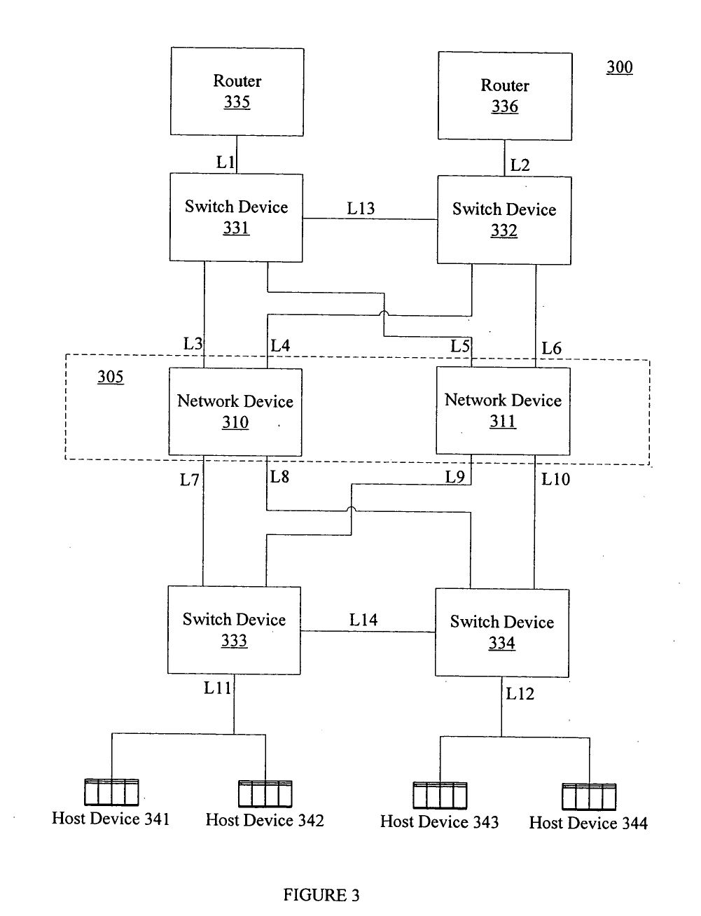

FIG. 3 illustrates an embodiment of system 300, which is arranged for neighbor cache table synchronization for a high-availability system. System 300 includes components such as switch devices 331-334, routers 335-336, host devices 341-344, links L1-L14, and HA system 305. HA system 305 includes network devices 310-311. It is understood that system 300 may include many more switch devices, host devices, routers, and links than are illustrated in FIG. 3. Also, topologies other than the topology illustrated in FIG. 3 may be employed. Components of system 300 may be arranged to operate in a similar manner to similarly-named components of system 100, and may operate in a different manner in some ways.

Switch devices 331-334 may each include a packet switch and the like, such as a bridge, a router, a layer-2 switch, a layer-3 switch, and the like. Routers 335-336 may each be arranged for routing packets by employing a protocol such as an Internet Protocol (IP) and the like. Also, each of the switch devices 331-334 is attached to a plurality of links. If a switch device receives a packet, it forwards the packets by transmitting it to another link. One or more of the switch devices may include a neighbor cache table.

In one embodiment, network devices 310-311 each include a firewall. In any case, each of the network devices 310-311 is attached to a plurality of links. If one of the network devices 310-311 receives a packet for forwarding, and the network device is assuming the master role, the network device forwards the packet by transmitting it to another link. Further, network devices 310 and 311 each include a neighbor cache table.

Host devices 341-344 may each be any network device capable of sending and receiving a packet over a network. The set of such devices may include devices that typically connect using a wired communications medium such as personal computers, multiprocessor systems, microprocessor-based or programmable consumer electronics, network PCs, and the like, that are configured to operate as a network device. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like, that are configured as a network appliance. Alternatively, host devices 341-344 may each be any device that is capable of connecting using a wired or wireless communication medium such as a PDA, POCKET PC, wearable computer, and any other device that is equipped to communicate over a wired and/or wireless communication medium, operating as a network device. As such, network devices 341-344 may each be configured to operate as a web server, cache server, file server, file storage device, proxy, and the like.

In one embodiment, switch devices 331-334 are layer-2 switches, and network devices 310 and 311 are layer-2 forwarding nodes. Switch device 331-331 and may each perform forwarding by employing its neighbor cache table. Each entry in the neighbor cache table pertains to a particular host. The host may be an end-host or a router. Also, each entry includes: a field that indicates the address of the host, a field that indicates the link onto which to reach the host, and a time field that is aged to discard the entry on expiration. Upon receiving a packet, the switch device adds an entry to the neighbor cache table. The added entry includes the source address of the packet in the address field, the link from which the packet was received in the link field, and a time entry.

Also, upon receiving a packet for forwarding, the switch device determines whether the destination address of the packet is included in an entry of the neighbor cache table. If so, the switch device forwards the packet to the link indicated in the link field of the entry.

In one embodiment, host device 341 may send a packet to router 335 by employing the Internet Protocol (IP). To accomplish this, host device 341 may send the packet to switch device 333. In one embodiment, switch device 333 sends the packet to link L7 based on a neighbor cache table in switch device 333. If the packet is transmitted to network device 310 through link L7, and network device 310 is the master, network device 310 forwards the packet. In one embodiment, network device 310 forwards the packet to link L3 based on the neighbor cache table of network device 310. Switch device 331 receives the packet at link L3 and forwards the packet. In one embodiment, switch device 331 forwards the packet to router 335 with link L1, based on a neighbor cache table in switch device 331.

Network device 310 is arranged to employ its neighbor cache table for forwarding packets if network device 310 is the master. Similarly, network device 311 is arranged to employ its neighbor cache table for forwarding packets if network device 311 is the master. In one embodiment, the neighbor cache table is hash-based for fast-lookup. The master may employ its neighbor cache table in a similar manner as described with regard to switch devices 331-334 above.

If network device 310 is not assuming the master role, it drops any packets it receives that were sent to network device 310 for forwarding. Similarly, if network device 311 is not assuming the master role, it drops any packets it receives that were sent to network device 311 for forwarding.

If network device 310 is assuming the master role, and a failure condition occurs in network device 310, the high-availability protocol may be employed so that network device 311 assumes the master role such that control of forwarding of the packets sent to high-availability system 305 for forwarding is failed over. In one embodiment, the high-availability protocol employs commands that are multicast to a high-availability multicast address. Network devices 310 and 311 are both members of the high-availability multicast group.

Further, network devices 310 and 311 employ a neighbor cache table synchronization protocol. The synchronization protocol may include commands such as Add, Delete, Ack, Sync-request, Sync-Ack, and Update. The synchronization protocol may enable high-availability system 305 to maintain synchronization of forwarding information so that when a fail-over occurs, traffic can be forwarded with relatively minimal latency and without disruption. If a fail-over occurs, since the neighbor cache tables are synchronized, traffic may continue to be forwarded quickly and efficiently.

In one embodiment, each command of the synchronization protocol may be sent by multicasting the protocol command to a multicast address that includes network devices 310 and 311. In one embodiment, the multicast address used for the synchronization protocol is the same multicast address that is used for the high-availability protocol. In other embodiments, the multicasting address used for the synchronization protocol may be different from the high-availability multicast address.

Also, as explained above, rather than employing a separate protocol, synchronization commands such as Add, Delete, Ack, Sync-request, Sync-Ack, and Update may be added to an existing protocol. In one embodiment, the commands Add, Delete, Ack, Sync-request, Sync-Ack, and Update are commands included to the address resolution protocol (ARP). In this embodiment, devices that are included in the synchronization multicast group are programmed to recognize and respond to these included ARP commands. However, the invention is not constrained to the ARP protocol, and other or new packet types may be employed. In one embodiment, these included ARP commands are multicast to the HA multicast group, as discussed above. These included ARP commands are subsequently referred to as HA ARP commands.

If the master (e.g. network device 310) adds a new entry to its neighbor cache table, it then sends an Add command to the backup (e.g. network device 311). The Add command includes the address indicated in the address field of the new entry. In one embodiment, the command also includes the link indicated in the link field of the new entry. In another embodiment, rather than including the link in the command, the link is implicitly indicated by transmitting the Add command using that link. The backup (e.g. network device 311), upon receiving the Add command, adds a new entry that includes the address indicated in the command, and which includes the link that was either explicitly or implicitly indicated by the Add command. In the embodiment in which the link is implicitly indicated, the link field of the new entry in the backup's neighbor cache table includes the link from which the Add command was received.

In one embodiment, if the master deletes an entry from its neighbor cache table, it sends a Delete command to the backup. In response to the Delete command, the backup deletes the corresponding entry from its neighbor cache table. In this embodiment, the master ages its neighbor entry and the backup does not age its entry. In another embodiment, the Delete command is not employed, and the backup ages its own neighbor cache table.

In one embodiment, the backup sends an Ack command to the master in response to receiving a proper Add or Delete command.

In one embodiment, when a network device (e.g. 310 or 311) first joins high-availability system 305, it sends a Sync-request command to the current master to request all entries in the current master's neighbor cache table. Upon receiving a Sync-request command, the current master sends Sync-Ack commands corresponding to the entries in the neighbor cache table of the master. In one embodiment, one Sync-Ack command is sent for every entry in the master's neighbor cache table. In another embodiment, addresses that have the same link field are combined into a single Sync-Ack command.

As with the Add command, in one embodiment, the link field is explicitly indicated in the Sync-Ack command, and in another embodiment, the link field is implicitly indicated by Sync-Ack command by transmitting the Sync-Ack command using the link that is in the link field of the neighbor cache table.

In one embodiment, when a network device (e.g. 310 or 311) becomes the master, either because a fail-over condition or after resuming the role of master after a reboot, upon becoming master, the network device sends an Update command for every entry in the neighbor cache table. The Update command is a packet that includes the address from the address field of the entry in the source address field of the packet. In one embodiment, the network device sends a copy of the Update command on each of its attached links, except the link that the neighbor is attached to.

In response to receiving an Update command, the neighbor switch devices (e.g. 331-334) are arranged to update their neighbor cache table, if any, and to redirect traffic to the new master. More specifically, when the neighbor switch device receives the Update command packet, it adds a new entry to the neighbor switch device's neighbor cache table. The address field of the new entry includes the address in the source field of the Update command packet. The link field of new entry includes the link that leads to the new master.

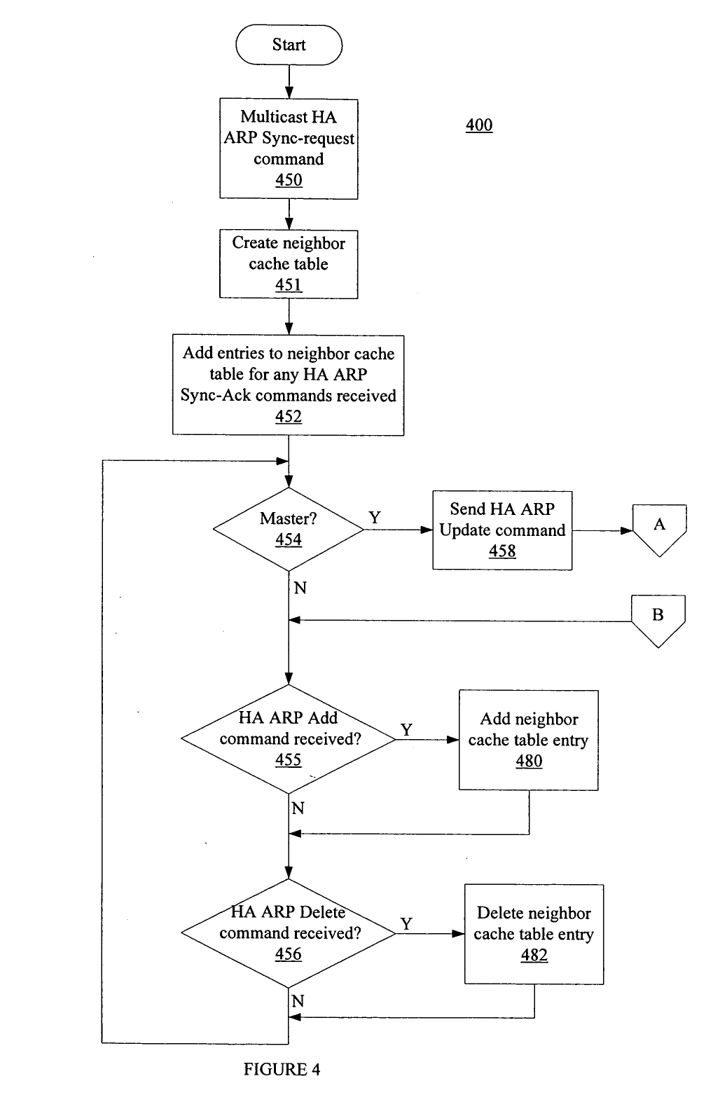

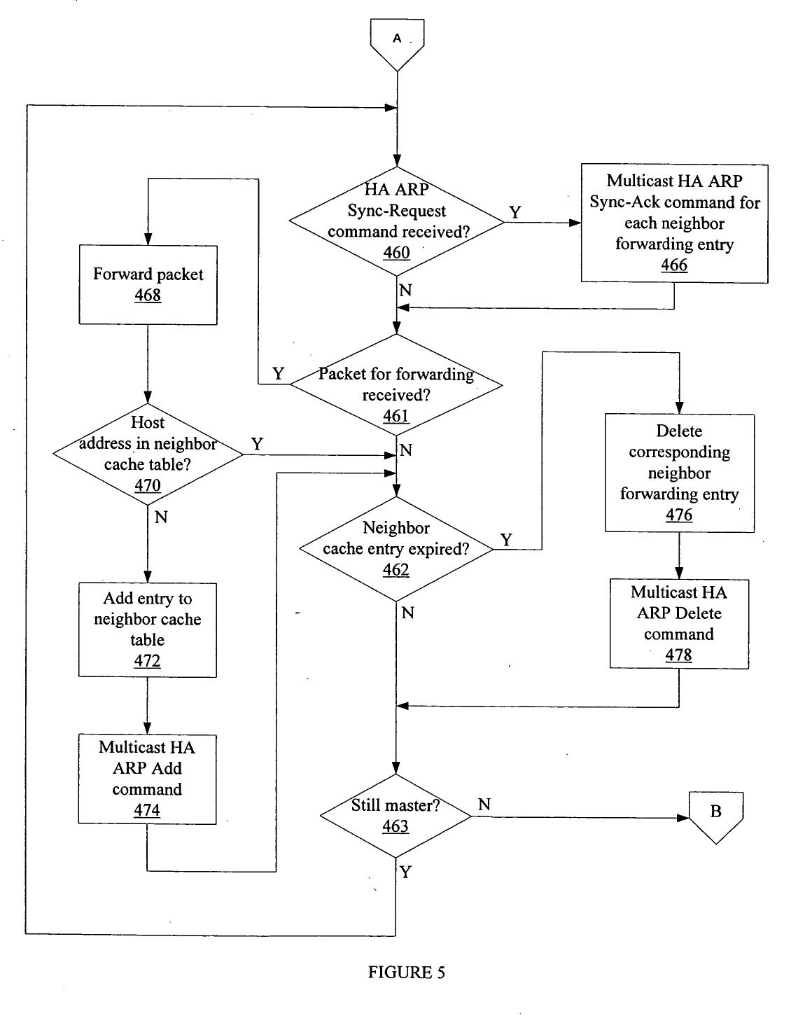

FIGS. 4-5 show a flow chart of an embodiment of process 400, which may be employed for neighbor cache table synchronization in a system, such as an HA system. In one embodiment, process 400 is employed by one or both of the network devices 310 and 311 of FIG. 3.

At a start block, a network device such as network 310 or network device 311 first comes on the link. The process then proceeds to block 450, where an HA ARP Sync-request command is multicast. The process then moves to block 451, where a neighbor cache table is created. The process then proceeds to block 452, where entries are added to the neighbor cache table in response to any Sync-Ack commands that may be received.

The process than proceeds to decision block 454, where a determination is made as to whether the network device is assuming the master role. If so, the process advances to block 458, where an HA ARP Update command is sent. The process then proceeds to decision block 460, where a determination is made as to whether a Sync-Request HA ARP command has been received. If so, the process moves to block 466, where an HA ARP Sync-Ack command is multicast for each neighbor forwarding entry in the neighbor cache table.

The process then advances to decision block 461, where a determination is made as to whether a packet for forwarding has been received. If so, the process proceeds to block 468, where the packet is forwarded. The process then advances to decision block 470, where a determination is made as to whether any of the entries in the neighbor cache table include the address of the host that sent the packet. If not, the process moves to block 472, where an entry for the host address is added to the neighbor cache table. The process then proceeds to block 474, where an HA ARP Add command for the host address is multicast.

The process then moves to decision block 462, where, for each entry in the neighbor cache table, a determination is made as to whether the time indicated in the time field of the entry has expired. If so, the process moves to block 476, where the expired entry is deleted. The process then proceeds to block 478, where an HA ARP Delete command for the expired entry is multicast. The process then advances to decision block 463, where a determination is made as to whether the network device is still assuming the master role.

If not, the process moves to decision block 455, where a determination is made as to whether an HA ARP Add command has been received. If so, the process proceeds to block 480, where an entry is added to the neighbor cache table in response to the HA ARP Add command. The process then advances to decision block 456, where a determination is made as to whether an HA ARP Delete command has been received. If so, the process proceeds to block 482, where an entry is deleted from the neighbor cache table in response to the HA ARP Delete command. The process then moves to decision block 454.

At decision block 454, if it is determined that the network device is not assuming the master role, the process advances to decision block 455. At decision block 455, if it is determined that an HA ARP Add command has not been received, the process advances to decision block 456. At decision block 456, if it is determined that an HA ARP Delete command has not been received, the process moves to decision block 454.

At decision block 470, if it is determined that the host address is already included in the neighbor cache table, the process proceeds to decision block 462. At decision block 462, if it is determined that the time included in the time field of the entry has not expired, the process advances to decision block 463. At decision block 463, if it is determined that the network device is still assuming the master role, the process moves to decision block 460. At decision block 460, if it is determined that a Sync-Request command has not been received, the process advances to decision block 461. At decision block 461, if a packet associated for forwarding has not been received, the process proceeds to block 462.

It is understood that the order of the determinations in decision blocks 460-463 shown in FIG. 5 are arbitrary, and may be performed in any order, or may be performed substantially simultaneously. Similarly, it is understood that the order of the determinations in decision blocks 455-456 shown in FIG. 4 are arbitrarily, and may be performed in any order, or may be performed substantially simultaneously. The order of these determinations shown in the figures is for illustrative purposes only and should not be construed as limiting.

The above specification, examples and data provide a description of the manufacture and use of the composition of the invention. Since many embodiments of the invention can be made without departing from the spirit and scope of the invention, the invention also resides in the claims hereinafter appended.

1. A network device for forwarding traffic on a network, comprising:
a transceiver; and
a processor that is arranged to perform actions, including:
if a synchronization request is received, enabling the transceiver to send a response to the synchronization request, wherein the response includes information associated with an entry in a first neighbor cache table;
if a deletion is made to the first neighbor cache table, enabling the transceiver to transmit information about the deletion to another network device to enable the other neighbor device to reflect the deletion in a second neighbor cache table; and
if another entry is added to the first neighbor cache table, enabling the transceiver to transmit information about the other entry to the other network device to enable the other neighbor device to reflect the other entry in the second neighbor cache table, wherein the other entry is associated with a host, and wherein the information about the other entry is transmitted over a link that is associated with the host.

2. The network device of claim 1, wherein the response is associated with another host, and wherein the response is transmitted over another link that is associated with the other host.

3. The network device of claim 1, wherein the each of the entries in the first neighbor cache table includes an address field that indicates an entry address, and further includes a link field that indicates which link is to be used to for forwarding to the entry address, and wherein the processor is further arranged to:
enable the transceiver to send a synchronization request;
receive another response to the synchronization request at a receiving link; and
add an additional entry to the first neighbor cache table based on the other response to the synchronization request such that the link field of the other entry includes the receiving link.

4. The network device of claim 1, wherein the processor is further arranged to:
enable the transceiver to send at least one command to enable a neighbor switch device to redirect traffic to the network device.

5. The network device of claim 4, wherein each of the entries in the first neighbor cache table includes an address field that indicates an entry address, and wherein processor is arranged to enable the transceiver to send the at least one command to enable the neighbor switch device to redirect traffic to the network device by:
for each entry in the first neighbor cache table, sending a packet that includes a source address field that includes the entry address.

6. A method for forwarding traffic on a network, comprising:
storing a first neighbor cache table in a network device;
storing a second neighbor cache table in a backup network device, wherein the backup network device is coupled to a plurality of links;
receiving a packet associated with a host address at a receiving link of the network device;
determining if the first neighbor cache table includes an entry associated with the host address;
if the first neighbor cache table does not include the entry, sending an add command from the receiving link to a first link of the plurality of links of the backup network device, wherein the add command includes the host address;
receiving the add command at the first link of the plurality of links; and
adding a new entry to the second neighbor cache table in response to the add command.

7. The method of claim 6, wherein each of the entries in the first and second neighbor cache tables includes an address field that indicates an entry address, and further includes a link field that indicates which link is to be used to for forwarding to the entry address, wherein the address field of the new entry includes the host address, and wherein the link field of the new entry includes the first link.

8. The method of claim 6, further comprising:
sending a synchronization request from the backup network device to the network device;
in response to the synchronization request, sending information associated with each of the entries in the first neighbor cache table to the backup network device in response to the synchronization request, wherein the information includes the entry address of the address field of each entry in the first neighbor cache table, and wherein each of the entry addresses is sent to the backup device by employing the link that is included in the link field of the entry in the first neighbor cache table that includes the entry address; and
for each of the entry addresses of the information:
receiving the entry address at one of the plurality of links of the backup network device; and
in response to the entry address, adding another new entry to the second neighbor cache table such that the address field of the other new entry includes the entry address, and such that the link field of the new entry includes the one of the plurality of links of the backup network device that received the entry address.

9. The method of claim 6, further comprising:
aging a time field that is included in each entry of the first neighbor cache table;
for each entry in the first neighbor cache table, determining if the time field of the entry has expired, and if it has expired:
deleting the entry from the first neighbor cache table;
sending a delete command from the network device to the backup network device, wherein the delete command is associated with the entry deleted from the first neighbor cache table; and
deleting another entry in the second neighbor cache table in response to the delete command.

10. The method of claim 6, wherein the add command is sent from the network device to the backup network device by multicasting the add command to a high-availability protocol multicast address.

11. The method of claim 6, further including:
for each entry in the first neighbor cache table, sending an update packet from the network device, wherein the update packet includes a source address field that includes the entry address of the entry; and
in response to at least one of the update packets, updating a third neighbor cache table in a neighbor switch device to redirect traffic to the network device.

12. A network device for forwarding traffic on a network, comprising:
a transceiver; and
a processor that is arranged to perform actions, including:
if the network device is assuming a master role:
receiving a plurality of packets, wherein a received packet in the plurality of packets is received at a receiving link, and wherein the received packet is associated with a host address;
determining if a first neighbor cache table includes an entry associated with the host address; and
if the cache table does not include the entry, enabling the transceiver to send the host address to a backup network device to enable the backup network device to synchronize a second neighbor cache table with the first neighbor cache table.

13. The network device of claim 12, wherein enabling the transceiver to send the host address to the backup network device is accomplished with the receiving link.

14. The network device of claim 12, wherein the processor is further arranged to enable the transceiver to send an update command to enable a neighbor switch device to redirect traffic to the network device.

15. The network device of claim 12, wherein the processor is further configured to, if the network device is assuming a master role:
receive a synchronization request; and
enable the transceiver to send information associated with each entry in the first neighbor cache table to the backup network device in response to the synchronization request, wherein each of the entries in the first neighbor cache table includes an address field that indicates an entry address, and further includes a link field that indicates which link is to be used to for forwarding to the entry address, the information includes the entry address of the address field of each entry in the first cache table, and wherein each of the entry addresses is sent to the backup device by employing the link that is included in that link field of the entry in the first neighbor cache table that includes the entry address.

16. The network device of claim 12, wherein the processor is further configured to:
for each entry in the first neighbor cache table, if the entry is deleted from the first neighbor cache table, enabling the transceiver to send a delete command to the backup network device.

17. The network device of claim 12, wherein the processor is further arranged to control forwarding of the plurality of packets if the network device is assuming a master role, and wherein the backup network device is arranged to control forwarding of the plurality of packets if the backup network device is assuming the master role.

18. The network device of claim 12, wherein each entry of the first neighbor cache table includes an address field that indicates an entry address, and further includes a link field that indicates which link is to be used for forwarding to the entry address; and wherein the processor is further arranged to:
if the network device is performing a backup role:
if an add command is received at another receiving link, adding an added entry to the first neighbor cache such that the added entry includes another host address that is associated with the add command in the address field of the added entry, and includes the other receiving link in the link field of the added entry; and
if a delete command is received, delete an entry that is associated with the delete command from the first neighbor cache table; and
if the network device changes from a backup role to a master role, for each entry in the first neighbor cache table, sending a packet that includes a source address field that includes the entry address of the entry.

19. A computer readable medium encoded with instructions for managing synchronization, comprising:
a means for providing high-availability with a first network device and a second network device; and
a synchronizing means for communicating neighbor cache table synchronization information between the first network device and the second network device.

20. The computer readable medium of claim 19, wherein the synchronizing means comprises at least one of an add command, an update command, a synchronize request command, and a synchronize acknowledge command.
